(19) United States
(12) Patent Application Publication
(10) Pub. No.: US 2022/0372708 A1
(43) Pub. Date: Nov. 24, 2022

(54) COATING FOR REDUCING OIL ABSORBENCY OF CELLULOSIC WEBS

(71) Applicant: Stora Enso OYJ, Helsinki (FI)

(72) Inventors: Kaj Backfolk, Lappeenranta (FI); Chris Bonnerup, Floda (SE); Isto Heiskanen, Imatra (FI); Katja Lyytikäinen, Imatra (FI)

(73) Assignee: Stora Enso OYJ, Helsinki (FI)

(21) Appl. No.: 17/755,339

(22) PCT Filed: Nov. 4, 2020
(86) PCT No.: PCT/IB2020/060348

§ 371 Date: Apr. 27, 2022

(30) Foreign Application Priority Data
Nov. 4, 2019 (SE) 1951260-7

(51) Int. Cl. D21H 19/52; D21H 19/34; D21H 19/12; C09D 101/28; B32B 23/06; B32B 27/10

(52) U.S. Cl. CPC D21H 19/52; D21H 19/34; D21H 19/12; C09D 101/286; B32B 23/06; B32B 27/10

(57) ABSTRACT

A method for reducing the surface oil absorption of cellulose based substrate is provided, in which a coating composition is applied to said substrate; and in which the coating composition comprises carboxymethyl cellulose (CMC) and/or a salt of carboxymethyl cellulose (CMC). A coated paperboard, and a laminate of the coated paperboard with a polymer layer is also provided. The coating composition provides improved surface oil absorption and improved adherence of an overlying polymer layer.

### TECHNICAL FIELD

The present invention relates to a thin bio-based coating that reduces oil absorbency of rough cellulosic substrates such as paperboard.

### BACKGROUND

One problem with rough substrates such as uncoated paperboard is that they have relatively high absorbency towards low or non-polar liquids such as oils or UV inks. A lower absorbency would be preferred e.g. in printing, which thus enables less ink uptake and faster curing. This property is not only needed for paper or paperboard but also various laminates thereof. When laminating with e.g. polyethylene, it is of crucial importance that the treatment layer does not impact negatively on the adhesion of the applied polymer layer.

Reduced oil absorption is an essential property in many food packaging applications including both various packaging papers and paperboards. Many synthetic chemicals or polymers used for oil repellency are either toxic, cause problems when recycled and reused, or might interfere with other chemicals when applied as a coating, Traditionally, fluorochemicals have been used to provide good barrier against oil and grease.

Moreover, many barrier chemicals may further pose a thermoplastic behavior, which might cause deposits when disintegrating the broke. Latex binders and dispersion barriers are known to increase the reject content but also to increase the risk for deposits on the paper machine.

One solution to the said problem would be a coating that has good oil barrier properties such as PVOH. However, the problem with such polymers is that they often cause blistering during drying and require further special cooking devices at the plant. Their viscosity and rheological properties are also very dependent on the temperature and consistency.

Today, paperboard is often surface-sized with starches. Some modified starches might reduce the oil absorbency, but do not typically provide a synergistic effect with any applied liquid and gas barrier layers.

The need remains for a novel coating and coating method for cellulose-based substrates such as paperboard which exhibit reduced oil absorption.

### SUMMARY

A method for reducing the surface oil absorption of a cellulose-based substrate is therefore provided, in which a coating composition is applied to the cellulose-based substrate; and in which the coating composition comprises carboxymethyl cellulose (CMC) and/or a salt of carboxymethyl cellulose (CMC). A coated cellulose-based substrate, and a laminate of the coated paperboard with a polymer layer is also provided. The coating composition provides improved (i.e. reduced) surface oil absorption while maintaining the adherence of an overlying polymer layer.

Additional details of the invention are described in the dependent claims.

### DETAILED DISCLOSURE

A method is thus provided for reducing the surface oil absorption of cellulose-based substrate such as a paperboard, typically an uncoated paperboard. Generally, the method comprises the step of applying a coating composition to at least one surface of said cellulose-based substrate; wherein said coating composition comprises carboxymethyl cellulose (CMC) and/or a salt of carboxymethyl cellulose (CMC), and allowing said coating composition to dry, so as to form a barrier layer on said cellulose-based substrate.

A coated substrate is also provided, which comprises a layer of cellulose-based substrate, and at least one barrier layer comprising carboxymethyl cellulose (CMC) and/or a salt of carboxymethyl cellulose (CMC).

Many packaged foods contain fats, e.g. pizza boxes, hamburger boxes, cereals, etc. The present invention therefore relates primarily to oil and grease which comes via food and which might migrate through the paperboard. The oil can also be residual oil components in the recycled fibers and the present technology would thus also reduce migration of those components.

Furthermore, printing inks typically contain oils or volatile organic components which are considered harmful if those should migrate to food. The present technology can provide improved barrier to such migration. Since the present invention reduce oil absorbency, it also enables faster ink drying and possibility to use less ink. The present technology can thus give better print when using e.g. oil-based inks, but also UV-based inks and varnishes.

Many oil barriers for packaged foods have latex-based coatings. The present technology allows the replacement of petroleum-derived coatings with bio-based coatings.

### Cellulose-Based Substrate

The present technology is applied to cellulose-based substrates such as packaging paper or paperboard. Paperboard is commonly known as “card” or “cardboard”. A paperboard normally has a grammage above 190 g/m². Paperboard can be single- or multi-ply.

One parameter of interest for the cellulose-based substrate is the PPS (Parker Print-Surf) Smoothness according to ISO 8791-4. This is a measure of the roughness of the cellulose-based substrate, which is important for subsequent printing or laminating processes. Accordingly, the cellulose-based substrate may have a PPS (Parker Print-Surf) Smoothness according to ISO 8791-4 prior to application of the coating composition which is greater than 1, preferably greater than 3, more preferably greater than 5, but less than 50 μm when determined at 1.0 MPa. PPS describes the roughness of the substrate, but it also important property when considering converting applications such as printing or coating. A less rough surface will provide better print and appearance, whereas a too dense and smooth surface will not necessarily accept sufficient coating liquid (if using contact coating methods).

Another parameter of interest is the oil absorption. In the present technology, oil absorption is measured by the SCAN-P 37:77 (30 seconds) method, which provides “Cobb-Unger values” in g/m². Prior to application of the coating composition, the cellulose-based substrate has a relatively high oil absorption, defined by a Cobb-Unger value measured after 30 s on the back side (bs) of at least 20 g/m². It should be understood that various fibers and fiber mixes can be utilized. Of course, if a very fine refined pulp is used, then the smoothness can be better. Also, addition of chemicals to the furnish may change the Cobb Unger value.

The paperboard used herein is a baseboard for liquid paperboard, but the invention is not limited to such paperboard grades. It can also be cup stock or other food packaging applications. The paperboard may be uncoated paperboard, surface sized paperboard, pigmented paperboard or single mineral coated paperboard and is preferably uncoated paperboard.

### Coating Composition

The coating composition comprises carboxymethyl cellulose (CMC) and/or a salt of carboxymethyl cellulose (CMC). CMC is a cellulose derivative with carboxymethyl groups (—CH₂—COOH) bound to some of the hydroxyl groups of the glucopyranose monomers that make up the cellulose backbone. The coating composition may comprise CMC and/or a salt of CMC in a concentration of between 1-100%, preferably between 10 and 90% and more preferably between 30 and 90% w/w. The coating composition is typically an aqueous solution of CMC.

One interesting parameter is the degree of substitution, i.e. how much of the cellulose is derivatised. The CMC according to one aspect has a degree of substitution (DS) from 0.05 to 0.5, preferably from 0.1 to 0.3. A lower degree of substitution provides improved adhesion of an overlying thermoplastic layer, and an improved Cobb-Unger value. Typically, degree of substitution (DS) is determined e.g. by titration methods such as disclosed in Ambjörnsson et al., (2013), Bioresources, 8(2), 1918-1932. It should be understood that salt content etc. will affect the titration results and therefore DS should be tested for blanks and for washed products. Without being bound to any theories, we believe that—due to the characteristic fiber and fibril structure—low DS CMC provides a better hold-out and hence more effective protective coating. A better “hold-out” means that the coatings stay better on the surface—thus a more effective coating can be achieved at a lower weight coat.

Another parameter of interest is the salt content. “Technical grades” of CMC have a salt content greater than 5%, and may be even 30-40%. According to the present invention, the CMC has a salt content of greater than 1 wt %, preferably greater than 2 wt % and more preferably greater than 5 wt %. High purity grades of CMC are often more viscous and expensive. In the present case, good barrier was achieved despite the fact that salt content was high. The salt may be residual salts from the carboxymethylation process or it might be added salt. The salt may be mono-, di- or trivalent metal salts and/or cations such as Na-, Ca-, Mg- or Al-salts.

The coating composition may further comprise an organic acid, preferably an organic polyacid; and/or a metal salt of an organic acid or organic polyacid. Suitable organic acids are selected from citric acid, lactic acid, acetic acid, formic acid, oxalic acid, 1,2,3,4-butanetetracarboxylic acid, malonic acid or tartaric acid, uric acid, or malic acid, preferably citric acid. Use of an organic acid allows the pH of the coating composition to be adjusted as required. In particular, the coating composition may be a buffered aqueous solution comprising an organic acid, preferably an organic polyacid, and a metal salt of said organic acid. The coating composition suitably has a pH between 3 and 7, preferably between 3 and 5. Organic acids such as citric acid function as cross-linking agents for the CMC. Preferably, the dry low DS CMC is first dispersed into a solution comprising citric acid, typically 1-60 wt % citric acid.

In particular, it seems that the optimal pH is between 3-5, e.g. about 4 for obtaining e.g. synergistic effect with e.g. moisture resistance. Traditionally, it has been understood that if the pH goes below 3 sodium CMC in solution becomes protonated, and CMC may precipitate. Also, a low pH is also a safety risk and might increase the risk for corrosion. At low pH and especially at higher temperature and longer storage time, polymer degradation starts to occur and CMC will lose some of its physico-chemical properties. However, it has been discovered that low DS CMC grades are much less affected by the pH and should be more thermostable. This allows also storage of the suspension at lower pH in mill condition without any significant changes in rheological properties. For high DS CMC grades, a very low pH will cause an undesirable increase in viscosity of the coating composition as described. Therefore—and counterintuitively—a lower pH allows simultaneous lower viscosity of the coating composition. As the viscosity remains low, this allows a higher solids content in the coating composition.

The preferred coating process for the coating composition is a roll or jet applicator combined with blade unit. Also other coating equipment such as roll coater, curtain coater, spray coater, film press, cast coater, transfer coater, gate roll size press and air knife may be used. Different versions of the blade coater exist and the present technology is not limited to the type of blade coaters. Due to the optimal viscosity (especially of compositions with low DS CMC) printing presses such as offset, rotogravure, reverse rotogravure, flexogravure, inkjet can be used to apply the coatings. The coating composition may be applied to the cellulose-based substrate in an amount of 0.5-10 gsm, preferably 1-5 gsm, more preferably about 2 gsm. In the present examples the coating composition was applied in an amount of about 2 gsm based on a gravimetric method.

The coating is applied in a single layer, or more than one layer. The number of applied layers is usually determined by the coating layer thickness and quality. Hence, according to the present method, the step of applying a coating composition is repeated two or more times such that more than one, such as e.g. 2, 3, 4, 5 or 10, barrier layers are formed. The coating can be prepared as wet-on-wet or with intermediate drying. It is also possible to combine one or several methods. The coating can be made on one side or both sides of the substrate.

Preferably the coating is made on dry substrate having a dry content of more than 70 wt % and more pref. more than 80 wt % and most pref. more 85 wt %. The said coating can also be performed as a pre-coating or interlayer coating for e.g. mineral or dispersion barrier coating. After application of the coating composition the cellulose-based substrate typically has a Cobb-Unger value measured after 30 s on the back side (bs) of less than 5 g/m².

The coating composition may also comprise one or more cellulose derivatives, such as CMC, hydroxyethyl cellulose (HEC), ethyl hydroxyethyl cellulose (EHEC) or methyl cellulose. In other words, it comprises a mixture of such cellulose derivatives (e.g. with higher DS) and low DS CMC.

Another feature of the invention is that low pH formulations can be prepared preferably by adding dry or substantially dry CMC or low CMC powder (solid content >80%) to a solution comprising the organic acid disclosed herein, pref. at least 1 wt % of the acid. The preferred temperature is 10-90° C., preferably 15-80° C. and more preferably 20-70° C. Without being bound to any theory, it is also considered that the solution has better storage stability and is less prone to microbial attack.

The mixing of the CMC and organic acid can be made with any conventional or high shear mixing units including microfluidizers, (higher pressure) homogenizators, rotor-stator mixers, aqueous counter collision, steam explosion or high shear treatment in presence of steam such as jet cooker, etc. The mixing and homogenization might also be made in one or several steps including one or several processing methods. The mixing and homogenization temperature can vary depending on the process methods. The mixing and homogenization might also be performed with one or several additives used in the formulation, including of pigments or nanofillers.

### Other Components of the Coating Composition

In order to adjust the processability and performance of the coating, various additives can be used such as dispersing agents, cross-linking agents, lubricants, colorants, fillers and adhesion promoters. Typical dispersing agents are e.g. polysaccharides and various gums, polyacrylic acids, etc. typically being non-ionic or anionic. Preferred components are anionic starch, modified starches such as hydroxypropylated starch or anionic cellulose derivatives such as sodium carboxymethyl cellulose having DS higher than 0.4, pref. higher than 0.5.

Typical nanofillers can be nanoclays, kaolin, bentonite, silica or silicates, titanium dioxide, calcium carbonate, talcum, etc. Most preferred is kaolin. Preferably, at least one part of the filler is a platy filler. Preferably, one dimension of the filler should have an average thickness or length of 1 nm to 10 μm. The mean average thickness D90 is within the provided size range. The particle size of mineral can be determined by e.g. laser scattering techniques. Therefore, the barrier layer comprises one or more fillers, such as one or more nanofillers, suitably in the range of 1-50% by weight. The one or more fillers may be selected from one or more of nanoclays, kaolin, bentonite, silica or silicates, titanium dioxide, calcium carbonate and talcum, preferably kaolin.

Lubricants can also be included e.g. calcium stearate, polyethylene emulsion, various triglycerides, glycerols or polyethylene glycol. etc. By lubrication we mean in this context fluidity in coating operations such as blade coating or spray.

### Laminate

The present technology also provides a laminate comprising the coated board described herein, and further comprising a thermoplastic polymer layer arranged on the surface of said barrier layer(s) opposite said layer of cellulose-based substrate.

Accordingly, the method described herein may further comprise the step of applying a thermoplastic polymer to said barrier layer(s), to form a laminate comprising the coated board described herein, and a thermoplastic polymer layer.

The thermoplastic polymer may be selected from polyethylene, polylactic acid, poly(glycolic acid), polypropylene, thermoplastic starch, ethyl vinyl alcohol (EVA), thermoplastic cellulose derivatives or blends or co-polymers thereof. The step of applying a thermoplastic polymer to said barrier layer(s), may be repeated two or more times to form such that more than one layer, such as 4-6 layers or 2-4 layers e.g. 2, 3, 4, 5, or 10 thermoplastic polymer layers are formed.

If a laminate comprises multiple layers of thermoplastic polymer, it is common that they are of different compositions; e.g. different polymers. Two polymers may be “different” in terms of their physical properties (e.g. average MW) or their chemical structures (e.g. the composite monomers).

Typically, application of the thermoplastic polymer to the underlying layer tikes place via extrusion, but other methods are also possible.

Upon CMC coating, the surface strength is increased greatly. Upon laminate formation, CMC coating may cause the adhesion force of the polymer layer to actually be higher than laminates which do not include a CMC coating.

### EXAMPLES

The coating recipes are shown in Table 1

“Ref” denotes uncoated paperboard. A 247 gsm uncoated paperboard was used as base paperboards in the experiments.

All coating trials were done with similar settings. A roll applicator and blade coating unit was used in the coating trials and the samples were run 3 times during the same station with interim drying. Drying of the coating was made with IR and hot air targeting to an end moisture content of 6-7 wt %.

E1 denotes trial 1 with the CMC SG025 solution which corresponds to a low degree of substitution NaCMC which was dispersed in citric acid solution to a concentration of 4.8 wt %. The solution was homogenized at high pressure to ensure homogeneity and disintegration of the non-dissolved NaCMC. The degree of substitution was 0.25.

E2 denotes the corresponding solution with 7 wt % platy kaolin (Barrisurf LC, Imerys) and 3 wt % nanoclay (Cloisite BYK) calculated based on the dry amount of NaCMC.

E3 is similar to E2 but without the platy kaolin pigment.

C1 is similar to E2 but with a NaCMC having Degree of Substitution about 0.5, which means that it dissolves in water. This sample was only dispersed in tap water and disintegrated using a high shear mixer.

C2 is based on a NaCMC having even higher degree of substitution, i.e. 0.75. The recipe was prepared in similar manner as for C1.

C3 is an example based on a mixture of low DS CMC (used in E1) and PVOH (Exceval AQ4101, Kuraray). The PVOH was a modified PVOH which was cooked about 2 hours at 90-95° C.

TABLE 1

| | Ref | E1 | E2 | E3 | C1 | C2 |
|---|---|---|---|---|---|---|
| CMC SG 025(4.8%) | | 100 | 100 | 100 | | |
| CMC SG 05 (5%) | | | | | 100 | |
| CMC SG 075 (5%) | | | | | | 100 |
| Platy kaolin | | | 7 | | 7 | 7 |
| Nanoclay | | | 3 | 3 | 3 | 3 |
| Moisture content, wt % | | 6 | 6 | 6 | 6 | 6 |
| pH | | 4 | 4 | 4 | 7.9 | 9.2 |
| Brookfield , 100 rpm (cP) | | 350 | 590 | 590 | 3200 | 2400 |
| Dry solids, wt % | | 5.1 | 5.2 | 5 | 5.2 | 5.5 |
| Cobb-Unger 30 s, bs, g/m² | 29.8 | 4.0 | 4.4 | 4.3 | 2.2 | 1.8 |
| PE adhesion | | Good | Good | Medium | Medium | medium |

The results from the physical testing are also shown in Table I

Samples E1 and E2 both show low Cobb Unger values and good PE adhesion.

1. A method for reducing the surface oil absorption of a cellulose-based substrate, said method comprising the step of:
applying a coating composition to at least one surface of said cellulose-based substrate, wherein said coating composition comprises carboxymethyl cellulose (CMC) and/or a salt of carboxymethyl cellulose (CMC); and,
allowing said coating composition to dry, so as to form a barrier layer on said cellulose-based substrate,
wherein said CMC has a degree of substitution (DS) from 0.05 to 0.5 and said coating composition further comprises an organic acid.

2. The method according to claim 1, wherein said CMC has a degree of substitution (DS) from 0.1 to 0.3.

3. The method according to claim 1, wherein the cellulose-based substrate—prior to application of the coating composition—is paperboard.

4. The method according to claim 1, wherein said coating composition comprises CMC and/or a salt of CMC in a concentration of between 1-100% w/w.

5. The method according to claim 1, wherein said CMC has a salt content greater than 1 wt %.

6. The method according to claim 1, wherein the organic acid comprises citric acid, lactic acid, acetic acid, formic acid, oxalic acid, 1,2,3,4-butanetetracarboxylic acid, malonic acid, tartaric acid, uric acid, malic acid, or combinations thereof.

7. The method according to claim 1, wherein coating composition is a buffered aqueous solution comprising an organic acid and a metal salt of said organic acid.

8. The method according to claim 1, wherein the coating composition has a pH between 3 and 7.

9. The method according to claim 1, wherein said coating composition is an aqueous solution of CMC.

10. The method according to claim 1, wherein said coating composition comprises one or more fillers in the range of 1-50% by weight.

11. The method according to claim 1, wherein said coating composition is applied in an amount of 0.5-10 gsm.

12. The method according to claim 1, wherein said coating composition further comprises one or more cellulose derivatives.

13. The method according to claim 1, further comprising the step of:
applying a thermoplastic polymer to said barrier layer(s) to form a laminate comprising the coated board and a thermoplastic polymer layer.

14. The method according to claim 13, wherein said thermoplastic polymer comprises polyethylene, polylactic acid, poly(glycolic acid), polypropylene, thermoplastic starch, ethylene vinyl alcohol, thermoplastic cellulose derivatives or blends, or co-polymers thereof.

15. The method according to claim 1, wherein the cellulose-based substrate has a PPS (Parker Print-Surf) Smoothness according to ISO 8791-4, prior to application of the coating composition, which is greater than 1 but less than 50 μm when determined at 1.0 MPa.

16. The method according to claim 1, wherein the cellulose-based substrate has a Cobb-Unger value (30 s, bs) of at least 20 g/m² prior to application of the coating composition; and a Cobb-Unger value (30 s, bs) of less than 5 g/m² after application of the coating composition, wherein the Cobb-Unger value is a measure of the oil absorption and measured by the SCAN-P 37:77 (30 seconds) method.

17. A coated substrate comprising:
a layer of cellulose-based substrate, and
at least one barrier layer comprising carboxymethyl cellulose (CMC) and/or a salt of carboxymethyl cellulose (CMC), wherein the CMC has a degree of substitution (DS) from 0.05 to 0.5, and
wherein said barrier layer further comprises an organic acid.

18. The coated substrate according to claim 17, wherein the organic acid comprises citric acid, lactic acid, acetic acid, formic acid, oxalic acid, 1,2,3,4-butanetetracarboxylic acid, malonic acid, tartaric acid, uric acid, malic acid, or combinations thereof.

19. The coated substrate according to claim 17, wherein said barrier layer further comprises one or more fillers in the range of 1-50% by weight.

20. The coated substrate according to claim 17, wherein the CMC has a degree of substitution (DS) from 0.1 to 0.3.

21. The coated substrate according to claim 17, wherein the cellulose-based substrate—prior to application of the coating composition—is paperboard.

22. A laminate comprising:
the coated substrate according to claim 17; and
a thermoplastic polymer layer arranged on the surface of said barrier layer(s) opposite said cellulose-based substrate.

23. The laminate according to claim 22, wherein said thermoplastic polymer comprises polyethylene, polylactic acid, poly(glycolic acid), polypropylene, thermoplastic starch or blends, or co-polymers thereof.

24. The laminate according to claim 22, wherein the cellulose-based substrate—prior to application of the coating composition is paperboard.
